(19) United States
(12) Patent Application Publication
(10) Pub. No.: US 2026/0310954 A1
(43) Pub. Date: Oct. 8, 2026

(54) REFERENCE FREE ALIGNMENT FOR MULTI-PREFERENCE OPTIMIZATION

(71) Applicant: Microsoft Technology Licensing, LLC, Redmond, WA (US)

(72) Inventors: Xuchao ZHANG, Sammamish, WA (US); Saravanakumar Rajmohan, Redmond, WA (US); Chetan Bansal, Seattle, WA (US); Taneesh Gupta, Bengaluru (IN)

(21) Appl. No.: 19/092,454

(22) Filed: Mar. 27, 2025

(51) Int. Cl. G06N 3/08; G06F 40/284; G06F 40/40

(52) U.S. Cl. CPC G06N 3/08; G06F 40/284; G06F 40/40

(57) ABSTRACT

The disclosed relates to a method and system for training language models using a reference-free multi-preference alignment approach. It addresses the challenge of aligning model outputs with human preferences by optimizing a contrastive loss function over selected responses. The method involves identifying candidate responses, calculating reward scores, and selecting a subset of responses for optimization. Deviations from mean reward scores are used to assign weights, and a weighted contrastive loss function is generated to update model parameters. This approach enhances model alignment by considering multiple preferences and mitigating biases toward brevity, resulting in richer and more detailed outputs.

### TECHNICAL FIELD

Embodiments pertain to artificial intelligence (AI) and machine learning technologies. Some embodiments relate to preference optimization methods for enhancing model alignment by reducing alignment biases. Some additional embodiments relate to using a reference-free alignment and reducing short responses.

### BACKGROUND

Machine learning models are computational algorithms designed to identify patterns and make decisions based on data. These models are integral to a wide range of applications, including natural language processing, image recognition, and predictive analytics. By learning from large datasets, machine learning models can improve their performance over time, making them valuable tools in various industries such as healthcare, finance, and technology.

One of the challenges in developing machine learning models is ensuring that they align with specific performance criteria and expectations such as human expectations. This alignment is important for applications where the model's output directly impacts operational efficiency or decision-making processes. To address this, various techniques have been developed to optimize model parameters based on preference data.

Direct Preference Optimization (DPO) is a method that simplifies the alignment process by directly optimizing a contrastive loss over paired preference data. Unlike traditional reinforcement learning approaches, DPO does not require explicit reward functions, making it computationally efficient and suitable for datasets with limited preference annotations. This method has become widespread in aligning models with predefined criteria, enabling them to generate outputs that are more consistent with desired outcomes.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a machine-learning model system according to some examples of the present disclosure.

FIG. 2 illustrates a flowchart of a method of a reference-free model training according to some examples of the present disclosure.

FIG. 3 illustrates a logical diagram of a computing device for training a machine-learning model and in some examples responding to inference requests according to some examples of the present disclosure.

FIG. 4 illustrates a block diagram of an example machine upon which any one or more of the techniques discussed herein may be performed.

### DETAILED DESCRIPTION

As large language models (LLMs) and other generative artificial intelligence (AI) models find widespread deployment in real-world applications—such as customer support, educational tutoring, and medical advice—ensuring that their outputs adhere to human values, quality standards, and usage guidelines has become a research objective. Alignment methods, such as Reinforcement Learning from Human Feedback (RLHF) and Direct Preference Optimization (DPO), have guided models toward producing safer, more helpful content that meets user expectations.

While many alignment techniques rely on a reference model, there is growing interest in reference-free alignment approaches. By directly optimizing from scalar rewards or scores, these methods sidestep complex ratio modeling and exploit richer information from datasets that annotate multiple positive and negative responses per query. Leveraging these diverse signals has been shown to improve downstream performance, indicating that reference-free alignment can offer more robust and transferable improvements in language model capabilities.

Traditional alignment formulations often adopt a pairwise stance, contrasting a single preferred response against a single dispreferred one. However, real-world user preferences are more nuanced. Users may have multiple acceptable responses to a given query, as well as several suboptimal or even unacceptable ones. In order to capture these nuances, Multi-Preference Optimization (MPO) techniques have been developed that jointly consider entire sets of positive and negative responses, enabling models to align with a richer, more representative distribution of desirable outputs.

Yet, MPO introduces new challenges, particularly the model's tendency to exploit dataset-induced biases toward brevity. Humans often produce concise training examples due to cognitive and economic constraints, inadvertently suggesting shorter answers as the norm. In contrast, users at inference time frequently prefer richer, more detailed explanations-especially for complex tasks requiring extended reasoning. Without careful design, a model may prematurely terminate responses, undermining genuine quality improvements. Merely normalizing by length has shown to be insufficient.

Disclosed in some examples are methods, systems, devices, and machines that implement a Reference-Free multi-preference alignment (REFA). REFA integrates deviation-based weighting, ensuring that responses far above or below average quality receive proportionally more influence and introduces length normalization coupled with an End of Sequence (EOS)-probability regularizer. The EOS token is a special token used to signify the conclusion of a sequence or text. These techniques mitigate dataset-induced biases and encourage models to produce the richer, detailed answers often required in real-world scenarios. REFA achieves state-of-the-art results, advancing the alignment techniques toward more robust, controllable, and preference-aware LLM training.

The technical problem addressed is that traditional language model alignment methods often inadvertently reinforce low-quality or overly short responses due to dataset-induced biases and limitations in existing optimization approaches. Specifically, human-generated training data typically skews toward brevity due to time and effort constraints, while users in deployment scenarios often seek more extensive, detailed answers. Additionally, existing methods can create contradictory optimization signals among high-quality responses and fail to properly account for response length variations. The technical solution involves implementing a reference-free alignment method called REFA that incorporates multiple novel components to overcome these challenges. The solution includes: (1) a deviation-based weighting mechanism that ensures responses far above or below average quality receive proportionally more influence, (2) a length normalization system coupled with an EOS-probability regularizer to prevent trivial short-response biases and encourage appropriately detailed outputs, and (3) a multi-preference optimization framework that allows multiple high-quality responses to improve collectively rather than compete against each other. This solution is implemented through a mathematically rigorous loss function that integrates these components while providing hyperparameter controls for fine-tuning the balance between response quality, length, and optimization dynamics.

In some examples, the REFA training procedure begins by identifying a dataset containing queries and their associated responses with scalar rewards, a learning rate η, and hyperparameters α, β, γ, and λ. The hyperparameters may be input by one or more users, and in some examples, the queries and associated responses are provided by the model that is being trained. In some examples, the rewards may be provided by a reward model.

Once the inputs are identified, REFA first samples a batch of queries and their corresponding responses with rewards. For each query in the batch, it computes the mean reward r̅ by averaging all rewards associated with that query's responses. Using this mean reward, the algorithm then splits the responses into two sets: Y+ containing responses with above-mean rewards, and Y− containing responses with at or below-mean rewards.

REFA proceeds to compute length-normalized log-probabilities for each response, ensuring that response length doesn't unfairly influence the probability calculations. It then calculates deviation-based weights using the formula wᵢ←exp(α(rᵢ−r̅)) where rᵢ represents the reward for response i and r̅ is the mean reward.

Next, REFA computes partition functions Ā by summing the weighted exponentials of log-probabilities for positive responses and B̅ by summing the weighted exponentials of log-probabilities for negative responses. REFA then calculates an EOS regularizer R(θ) to control response termination behavior. The EOS (end-of-sequence) regularizer is calculated by examining the probability of ending a response at each position where responses actually end in the training data. For each response in both the positive and negative sets, the system evaluates how likely the model is to generate an end token at the position where that response naturally concludes. These probabilities are then weighted by a scaling factor (lambda) that controls how strongly the regularizer influences the overall training process.

This regularizer helps prevent the model from ending responses too early or producing overly short outputs. It achieves this by either penalizing the model when it wants to end responses prematurely or rewarding it for continuing responses to an appropriate length. The scaling factor can be adjusted to encourage longer, more detailed responses when needed or to promote more concise outputs when the model tends to be overly verbose.

The regularizer addresses a common problem where training data often contains shorter responses due to human annotators' tendency to write brief answers, while actual users typically prefer more detailed explanations. By incorporating this regularizer into the training process, the system can better align the model's output length with real-world user preferences rather than being constrained by the brevity bias present in the training data.

Finally, the system computes the loss function for the current query by combining the partition functions with the regularizer.

After processing all queries in the batch, the algorithm computes the overall batch loss by averaging the individual REFA losses. Finally, it updates the model parameters θ using gradient descent with the calculated learning rate η, moving the parameters in the direction that reduces the batch loss. This process continues iteratively until the model converges to an optimal state.

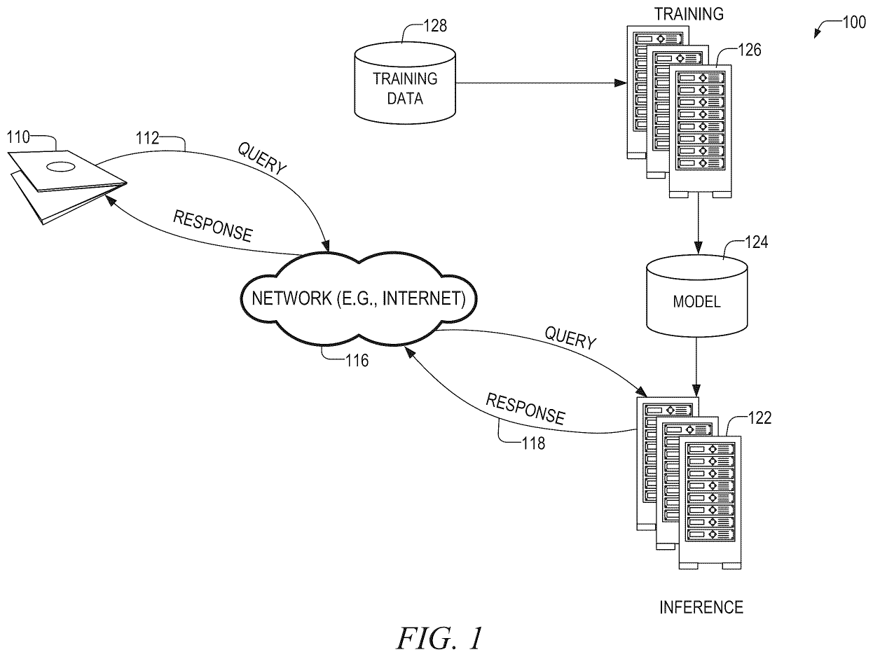

FIG. 1 shows a machine-learning model system 100 according to some examples of the present disclosure. The system 100 includes a user computing device 110, which is configured to send a query 112 over a network 116, such as the Internet. The network 116 facilitates communication between the user computing device 110 and an inference service 122, which processes the query 112 and generates a response 118. This response 118 is then transmitted back to the user computing device 110. In some examples, the query 112 may be a prompt and the response 118 may be text, images, videos, or the like. In some examples the inference service 122 executes on one or more server computing devices.

The inference services 122 uses a model 124 to generate the response 118 from the query 112. For example, the model 124 may be a generative Artificial Intelligence model such as a language model. Example language models may include large language models (LLMs). The model 124 is trained using a training service 126, which utilizes training data 128 to create model 124. In some examples, this process involves learning weights and biases of neurons within a neural network. In some examples, the training service 126 may utilize the REFA method disclosed herein. In some examples the training service 126 executes on one or more server computing devices.

In some examples, the training service 126 and the inference service 122 may be implemented on the same computing system. This configuration allows for seamless integration between training and inference processes, enabling real-time updates to the model 124 as new training data 128 becomes available. By sharing computational resources, this setup can reduce latency and improve the efficiency of model updates, ensuring that the model 124 remains current and responsive to evolving data patterns and user queries.

Alternatively, the training service 126 and the inference service 122 may be deployed on separate computing systems. This separation can be advantageous in scenarios where the training process requires significant computational power and resources, which may not be feasible to maintain on the same system as the inference component. By distributing the workload across different systems, organizations can optimize resource allocation, ensuring that both training and inference processes operate efficiently. This configuration also allows for greater flexibility in scaling each component independently, accommodating varying demands for training and inference tasks.

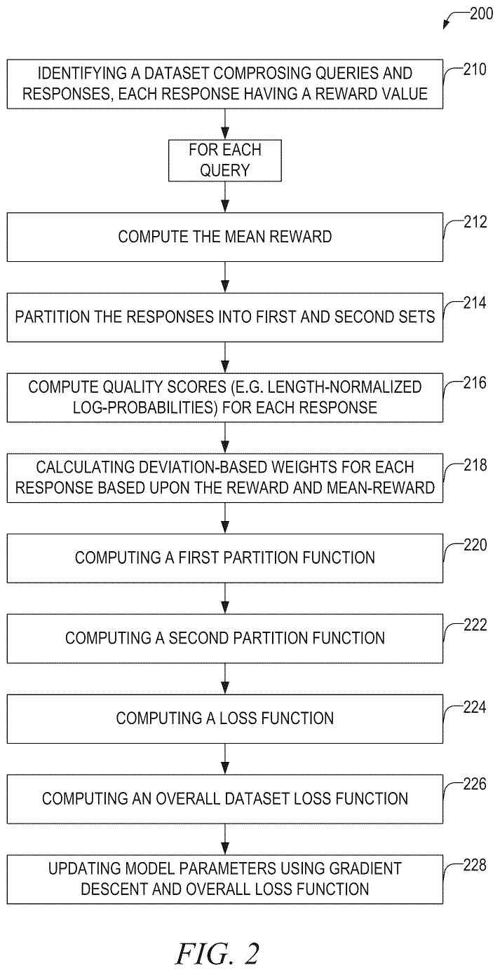

FIG. 2 illustrates a flowchart of a method 200 of a reference-free model training according to some examples of the present disclosure.

At operation 210, the method includes identifying a dataset comprising queries and associated responses, each response having a reward value. The responses may include multiple positive and negative examples per query to enable multi-preference optimization. The queries and responses may be prespecified, e.g., using commercial training data, or may be generated by the model. In some examples, the model may generate the responses to prespecified queries. In other examples, the model may also generate the queries.

At operation 212, for each query, the method computes a mean reward by averaging rewards associated with the responses. This establishes a baseline for partitioning responses and calculating deviations. At operation 214, the method partitions the associated responses into a first set containing responses with associated rewards that are above the mean reward and a second set containing responses with associated rewards that are below the mean reward. This enables collective optimization over groups of responses rather than pairwise comparisons.

At operation 216, the method computes quality scores (e.g., length-normalized log-probabilities) for each response, where the quality score represents an average measure of the language model's certainty in generating each token in the response. This normalization prevents unfair advantages for shorter responses by averaging across tokens.

At operation 218, the method calculates deviation-based weights for each response based on a difference between the response's associated reward and the mean reward. The weights may be calculated using exponential weighting to emphasize responses that deviate significantly from the mean quality. At operation 220, the method computes a first partition function by applying the deviation-based weights to the length-normalized log-probabilities and summing resulting weighted values for responses in the first set. At operation 222, the method computes a second partition function by applying the deviation-based weights to the length-normalized log-probabilities and summing resulting weighted values for responses in the second set.

In some examples (but not shown in the Figure), the method calculates an end-of-sequence (EOS) regularizer by determining probabilities of generating an end token at positions corresponding to annotated response endings in the dataset and applying a scaling factor to the determined probabilities. This helps prevent premature response termination and dataset-induced length biases.

At operation 224, the method computes a loss function by combining the first partition function, second partition function, and in some examples, the EOS regularizer. This unified loss function enables simultaneous optimization of multiple preferences while maintaining length control.

At operation 226, the method computes an overall dataset loss by averaging individual loss functions across the dataset. At operation 228, the method updates model parameters using gradient descent based on the overall dataset loss to improve the model's alignment with desired preferences.

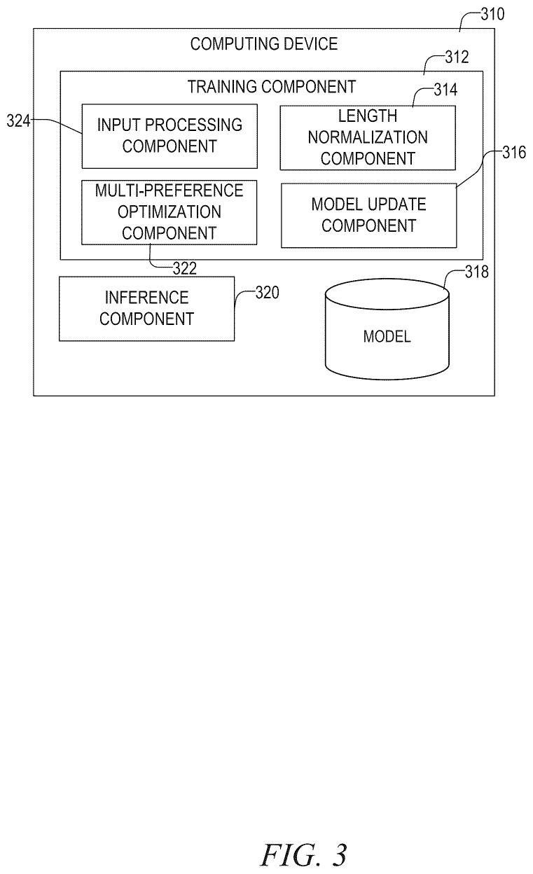

FIG. 3 illustrates a logical diagram of a computing device 310 for training a machine-learning model 318 and in some examples responding to inference requests according to some examples of the present disclosure. Computing Device 310 includes several components that enable reference-free alignment training and inference for language models. The Training Component 312 serves as the central coordinator for the training process, orchestrating multiple specialized components to implement the reference-free alignment methodology.

The Input Processing Component 324 handles the initial stages of training by receiving queries and their associated responses. In some examples, this component calculates mean reward scores from response ratings, uses these scores to partition responses into positive and negative sets, and computes deviation-based weights by analyzing the differences between individual response rewards and the mean scores. The Length Normalization Component 314, in some examples, manages response length considerations by calculating per-token log probabilities for each response and performing length normalization through token averaging. This component also applies EOS probability regularization to control response length and prevent unfair advantages that might arise from shorter responses.

The Multi-Preference Optimization Component 322 handles the optimization process by computing partition functions for both positive and negative response sets. It applies the previously calculated deviation-based weights to responses and combines these weighted values to enable simultaneous processing of multiple preference signals. The Model Update Component 316 manages the final stages of the training process by computing the overall loss function. This component combines partition functions from positive and negative sets along with EOS regularization terms and uses these to update model parameters through gradient descent optimization.

The system includes a Model 318 that undergoes training through the reference-free alignment process, and an Inference Component 320 that utilizes the model 318 to process inference requests using the trained model to generate responses to queries. For example, the model can be used in customer support applications to provide comprehensive answers to user inquiries, in educational tutoring scenarios to offer thorough explanations and guidance, and in medical advisory contexts to deliver detailed medical information. The model may be used to provide summaries, develop computer code, answer questions, and the like.

### Notation and Preliminaries

In this section, the notation and concepts used below are established. The system utilizes a reference-free multi-preference alignment where each query can be paired with multiple responses of varying quality. The objective is to shape the policy distribution so that it assigns higher probability mass to higher-quality responses, while pushing the probabilities of lower-quality ones closer to zero.

Queries and Responses Let X denote the space of possible queries. For each query x∈X, consider a set of candidate responses

$${\{ {𝓎}_{i} \}}_{i = 1}^{K} ⊆ y .$$

Each response [symbol] ᵢ is a sequence of tokens whose length is denoted by | [symbol] ᵢ|. This length | [symbol] ᵢ| plays a role in later sections, where length normalization is introduced to prevent trivial short-response biases.

Policy Model A policy model π_{θ}( [symbol] |x), parameterized by θ, is considered that assigns probabilities to candidate responses for each query. In particular, π_{θ}( [symbol] |x)=exp(log π_{θ}( [symbol] |x)), where log π_{θ}( [symbol] |x) is the log-probability of [symbol] . The model is reference-free, meaning it does not rely on a fixed baseline distribution μ( [symbol] |x).

Rewards and Mean Rating Each response | [symbol] ᵢ| to a query x is associated with a scalar reward rᵢ=r(x, [symbol] ᵢ), which can be interpreted as a measure of the response's quality.

$$Let \overline{r} = \frac{1}{K} {\sum }_{i = 1}^{K} {r}_{i}$$

denote the mean reward across the candidate responses. A positive set is defined: Y⁺={ [symbol] ᵢ|rᵢ>r̅} consisting of responses with above-mean ratings, and the negative set Y⁻={ [symbol] ᵢ|rᵢ>r̅} composed of responses at or below the mean rating.

Target Distribution and Multi-Preference Alignment Some alignment methods within the REFA family, such as the Info Noise Contrastive Alignment (InfoNCA) variant, incorporate a target distribution derived from the rewards. This involves introducing a temperature parameter α>0 and defining

$${p}_{i}^{target} = \frac{{e}^{{α r}_{i}}}{{\sum }_{j = 1}^{K} {e}^{{α r}_{j}}} .$$

The REFA-InfoNCA method encourages the model distribution to align with

$${p}_{i}^{target} ,$$

thereby treating all responses according to their relative quality as encoded by the rewards. In contrast, other proposed variants of REFA directly seek to drive down the probability of negative responses without relying on this target distribution.

Deviations and Weighting To capture nuanced differences among responses beyond simple binary classification as positive or negative, deviation-based weighting is considered. Let ΔSᵢ=rᵢ−r̅ΔSᵢ for example [symbol] ᵢ=e^{αΔS}^{ᵢ}, allows the system to emphasize highly positive responses more strongly and penalize significantly negative ones more intensely.

Length Normalization and EOS Regularization Language models may find certain token sequences easier to predict, causing shorter responses to be disproportionately favored due to their higher probability. To prevent trivial solutions such as always producing very short responses, length normalization is applied. Instead of using log π_{θ}( [symbol] |x) directly, a length-normalized quantity is applied ensuring that the measure of quality is not conflated with response brevity.

$$\overline{{logπ}_{θ} ( 𝓎 \vert x )} = \frac{1}{\vert 𝓎 \vert} {\sum }_{tokens t ∈ 𝓎} {log P}_{θ} ( t \vert context ) ,$$

Furthermore, to maintain control over response lengths, an end-of-sequence (EOS) regularizer is introduced that penalizes placing excessive probability mass on early termination tokens. This regularizer provides finer control over response length and ensures that improved alignment does not emerge solely from truncating responses.

Hyperparameters Several hyperparameters regulate the behavior of the reference-free multi-preference alignment framework. The parameter α influences how rating differences translate into distributional adjustments or weighting schemes. The parameter β acts as an inverse temperature that sharpens or smooths distributions derived from the model's log-probabilities. The parameter γ controls how strongly negative responses are penalized relative to positive ones. Finally, the parameter λ weights the length or EOS-based regularizer, thereby adjusting the extent to which sequence length considerations factor into the optimization. By tuning (α, β, γ, λ), it becomes possible to adapt the training objective to various tasks, data distributions, and desired response characteristics, ensuring that improvements in alignment reflect enhancements in response quality.

### Deriving the REFA Loss Function

In this section, a step-by-step derivation of an example REFA loss function is derived, starting from the InfoNCA formulation, removing reference models, introducing multi-preference sets, incorporating deviation-based weighting, length normalization, and finally addressing length-related biases through an EOS-regularization mechanism.

### Preliminary Setup and Notation

Consider a query x∈X and a set of candidate responses

$${\{ {𝓎}_{i} \}}_{i = 1}^{K} ⊆ y .$$

Each response [symbol] is a sequence of tokens, and the full context is defined (e.g., prompt or conversation history) under which [symbol] is generated as context :=(x). The policy model π_{θ}( [symbol] |context) assigns probabilities to responses conditioned on this context. Throughout this section, the term “context” encompasses all relevant conditioning information available to the model, including the query x.

Each response [symbol] is assigned a scalar reward [symbol] and the mean reward is defined as

$$\overline{r} : = \frac{1}{K} {\sum }_{i = 1}^{K} {r}_{{𝓎}_{i}} .$$

Based on this, responses are partitioned into:

$${Y}^{+} = \{ y \vert {r}_{𝓎} > \overline{r} \} , \qquad ( 1 )$$

$${Y}^{+} = \{ y \vert {r}_{𝓎} \leq \overline{r} \} . \qquad ( 2 )$$

To handle variable-length sequences, the length-normalized log-likelihood of a response is defined as:

$$\overline{{logπ}_{θ} ( 𝓎 \vert x )} = \frac{1}{\vert 𝓎 \vert} {\sum }_{tokens t ∈ 𝓎} {log P}_{θ} ( t \vert context ) . \qquad ( 3 )$$

This ensures that per-token quality is measured independently of the response length.

### From InfoNCA to Reference-Free Alignment

The InfoNCA approach originally assumes access to a fixed reference model μ( [symbol] |x) and aligns the ratio

$$\frac{{π}_{θ} ( {𝓎}_{i} \vert x )}{μ ( {𝓎}_{i} \vert x )}$$

to a distribution induced by rewards. In its original form, given a target distribution

$${p}_{i}^{target}$$

p derived via a softmax over rewards, the InfoNCA loss can be expressed as:

$${L}_{infoNCA} ( θ ) = - {\sum }_{i = 1}^{K} {p}_{i}^{target} {log p}_{i}^{model} , \qquad ( 4 )$$

$$where$$

$${p}_{i}^{model} = \frac{\frac{{π}_{θ} ( {𝓎}_{i} \vert x )}{μ ( {𝓎}_{i} \vert x )}}{{\sum }_{j = 1}^{K} \frac{\frac{{π}_{θ} ( {𝓎}_{i} \vert x )}{{π}_{θ} ( {𝓎}_{i} \vert x )}}{μ ( {𝓎}_{i} \vert x )}} .$$

Removing the Reference Model: Eliminating the reference distribution μ( [symbol] |x) yields a simpler, reference-free setting. Without μ, the model distribution directly becomes:

$${p}_{i}^{m odel} = \frac{{π}_{θ} ( {𝓎}_{i} \vert x )}{{\sum }_{j = 1}^{K} {π}_{θ} ( {𝓎}_{j} \vert x )} . \qquad ( 5 )$$

However, this direct approach has several issues: it can promote low-quality responses, create contradictory optimization signals among high-quality responses, and fail to distinguish subtle differences in reward quality.

### Multi-Preference Alignment Via Positive and Negative Sets

To address these weaknesses, consider a multi-preference formulation rather than focusing on pairwise or single-response comparisons, responses may be split into sets Y⁺ and Y⁻. It is desired to collectively increase probabilities for all x∈Y⁺ and decrease probabilities for all x∈Y⁻. A starting point is:

$$L ( θ ) = - log \frac{{\sum }_{y ∈ Y} + {π}_{θ} ( 𝓎 \vert x )}{{\sum }_{y ∈ Y} + ⋃ Y - {π}_{θ} ( 𝓎 \vert x )} . \qquad ( 6 )$$

This ensures that to decrease L(θ), the model must raise the relative mass of Y⁺ and reduce that of Y⁻. Yet, this basic version treats all responses in Y⁺or Y⁻ equally, ignoring finer reward gradations.

### Deviation-Based Weighting and Hyperparameters

To incorporate the full spectrum of quality differences, a deviation-based weighting may be used defined by:

$$Δ {S}_{y} = {r}_{y} - \overline{r} , {𝓌}_{𝓎} = {e}^{αΔ {S}_{y}} , \qquad ( 7 )$$

where α>0 controls how strongly reward deviations influence weighting.

Inverse-temperature parameters β and a negative-set weighting factor γ are also introduced. The inverse temperature β sharpens or smooths the distribution, and γ>0 controls how heavily to penalize the negative set. Incorporating these parameters and weights:

$$L ( θ ) = - log \frac{{\sum }_{y ∈ Y} + {e}^{β ( log {π}_{θ} ( 𝓎 \vert x ) + αΔ {S}_{𝓎} )}}{{\sum }_{y ∈ Y} + {e}^{β ( log {π}_{θ} ( 𝓎 \vert x ) + αΔ {S}_{𝓎} )} + γ {\sum }_{𝓎 ∈ Y} - {e}^{β ( log {π}_{θ} ( 𝓎 \vert x ) + αΔ {S}_{y} )}} \qquad ( 9 )$$

This aligns the model distribution such that high-deviation (high-quality) responses in Y⁺ gain more probability, and low-quality responses in Y⁻ are penalized more intensely.

### Length Normalization and EOS Probability Regularization

Without length normalization, shorter responses gain an unfair advantage as they have fewer tokens to predict. To counter this, log π_{θ}( [symbol] |x) is replaced with its length-normalized counterpart log π_{θ}( [symbol] |x) as defined in Eq. equation 3:

$$L ( θ ) = - log \frac{{\sum }_{y ∈ Y} + {e}^{β ( \overline{log {π}_{θ}} ( 𝓎 \vert x ) + αΔ {S}_{𝓎} )}}{{\sum }_{y ∈ Y} + {e}^{β ( \overline{log {π}_{θ}} ( 𝓎 \vert x ) + αΔ {S}_{𝓎} )} + γ {\sum }_{𝓎 ∈ Y} - {e}^{β ( \overline{log {π}_{θ}} ( 𝓎 \vert x ) + αΔ {S}_{y} )}} \qquad ( 10 )$$

Finally, due to dataset-induced biases and the risk of models exploiting length shortcuts, an EOS-regularization term R(θ) is introduced. This term encourages or discourages early termination, ensuring that the model does not trivially shorten responses to reduce loss. The final REFA objective is:

$${L}_{R E F A} ( θ ) = - log \frac{{\sum }_{y ∈ Y} + {e}^{β ( \overline{log {π}_{θ}} ( 𝓎 \vert x ) + αΔ {S}_{𝓎} )}}{{\sum }_{y ∈ Y} + {e}^{β ( \overline{log {π}_{θ}} ( 𝓎 \vert x ) + αΔ {S}_{𝓎} )} + γ {\sum }_{𝓎 ∈ Y} - {e}^{β ( \overline{log {π}_{θ}} ( 𝓎 \vert x ) + αΔ {S}_{y} )}} + ℛ ( θ ) \qquad ( 11 )$$

### Example Algorithm

The following is an example algorithm that outlines how to train a model with the proposed REFA loss. A dataset of queries and associated responses with scalar rewards is assumed, as well as known hyperparameters.

Algorithm 1: REFA Training Procedure

$Input : Dataset \{ ( x , {\{ ( x , {\{ {y}_{i} , {r}_{i} \}}_{i = 1}^{K} ) \}}_{n = 1}^{N} , learning rate η , hyperparameters α , β , γ , λ$
1 repeat
2 | Sample a batch of queries {x} and their responses {yᵢ, rᵢ};
3 | foreach query x in the batch¹ do
4 $\vert \vert Compute mean reward : \overline{r} ← \frac{1}{K} {\sum }_{i = 1}^{K} {r}_{i} ;$
5 $\vert \vert Split response : {Y}^{+} ← \{ {y}_{i} \vert {r}_{i} > \overline{r} \} , {Y}^{-} ← \{ {y}_{i} \vert {r}_{i} \leq \overline{r} \} ;$
6 | |Compute length-normalized log-probs: l̅o̅g̅ π̅_̅{̅θ̅}̅ (yi|x);
7 | |Compute deviation-based weights: [symbol] ← exp(α(rᵢ -r̅));
8 $\vert \vert Compute : \overline{A} ← {\sum }_{y ∈ {Y}^{t}} {e}^{β ( \overline{{log π}_{θ}} ( y \vert x ) + α ( {r}_{y} - \overline{r} ) )} ;$
9 | $\overline{B} ← {\sum }_{y ∈ {Y}^{-}} {e}^{β ( \overline{{log π}_{θ}} ( y \vert x ) + α ( {r}_{y} - \overline{r} ) )} ;$
10 Compute EOS regularizer [symbol] (θ);
$11 Compute loss : {L}_{R E F A} ( θ ) ← - log ( \frac{\overline{A}}{\overline{A} + γ \overline{B}} ) + ℛ ( θ ) ;$
12 end
$13 Compute batch loss : {L}_{b a t c h} ( θ ) ← \frac{1}{\vert batch \vert} {\sum }_{n} {L}_{REFA} ( θ ) ;$
14 Update parameters: θ ← θ - η∇_{θ}L_{batch} (θ);
15 until convergence;

Explanation: The algorithm implements a contrastive learning approach for response alignment. At each iteration, it samples query-response pairs (line 2) and computes mean rewards (line 4) to partition responses into above-mean (Y⁺) and below-mean (Y⁻) sets (line 5). Length-normalized log-probabilities (line 6) prevent degenerate solutions, while deviation-based weights (line 7) sharpen the preference signal.

The core learning objective aggregates weighted probabilities through partition functions A and B (lines 8-9), with an EOS regularizer R(0) (line 10) to control response termination. The final loss (line 11) drives gradient updates to optimize the model's policy distribution (lines 13-14).

### Theoretical Analysis

The central theoretical insights derived from the reference-free multi-preference alignment framework are now highlighted. Starting from a reference-free version of the InfoNCA objective issues are identified, such as encouraging low-quality responses and creating contradictory optimization signals—when dealing with multiple responses of varying quality. It is then shown that length normalization and additional regularizers (like EOS probability control) address subtle incentives that arise due to the relationship between sequence length and token-level uncertainty.

### Single-Term Objectives and Their Gradients

In a reference-free setting, the InfoNCA loss reduces to a cross-entropy objective over multiple candidate responses. However, analyzing it at the granularity of single responses (i.e., single-term objectives) reveals how the model's gradient signals can inadvertently promote low-quality outputs.

Lemma 1 (Gradient of a Single-Term Objective).

$$Let {ℓ}_{i} ( θ ) := - {p}_{i}^{target} log {p}_{i}^{m odel} ,$$

where

$${p}_{i}^{m odel} = \frac{π θ ( {y}_{i} \vert x )}{{\sum }_{j = 1}^{K} {π}_{θ} ( {y}_{i} \vert x )}$$

and

$${p}_{i}^{target} > 0 .$$

Suppose π_{θ}(yᵢ|x)>0 for all j. Then:

$$\frac{\partial {ℓ}_{i} ( θ )}{\partial {π}_{θ} ( {y}_{i} \vert x )} = - {p}_{i}^{t a r g e t} ( \frac{1}{{π}_{θ} ( {y}_{i} \vert x )} - \frac{1}{{\sum }_{j} {π}_{θ} ( {y}_{i} \vert x )} ) ,$$

And for each j≠i,

$$\frac{\partial {ℓ}_{i} ( θ )}{\partial {π}_{θ} ( {y}_{i} \vert x )} = {p}_{i}^{target} \frac{1}{{\sum }_{k} {π}_{θ} ( {y}_{k} \vert x )} .$$

Proof Sketch: 1. Express [symbol] ᵢ(θ) in terms of log π_{θ}(yᵢ|x) and log(Σⱼ π_{θ}(yⱼ|x)). 2. Differentiate w.r.t. π_{θ}(yᵢ|x) using the chain rule:

$${\partial }_{{π}_{θ ( {y}_{i} \vert x )}}$$

log π_{θ}(yᵢ|x)=1/π_{θ}(yᵢ|x) and ∂_{π}_{_{θ}}_{(y}_{ᵢ}_{|x)} log(Σⱼπ_{θ}(yⱼ└x))=1/Σⱼπ_{θ}(yᵢ└x). 3. For j≠i, only the denominator Σⱼπ_{θ}(yⱼ└x) affects the gradient.

Lemma 2: (Directional Influence of a Single-Term Objective). Under the same assumptions as Lemma 1, minimizing [symbol] ᵢ(θ) encourages increasing π_{θ}(yᵢ|x) (especially if initially small) and decreasing π_{θ}(yᵢ|x) for j≠i.

Proof Sketch: 1. From Lemma 1, note that if π_{θ}(yᵢ|x) is small, then

$$\frac{\partial {ℓ}_{i}}{\partial {π}_{θ} ( {y}_{i} \vert x )} < 0 ,$$

so increasing π_{θ}(yᵢ|x) reduces

$${ℓ}_{i} ( θ ) . 2. For j \neq i , \frac{\partial {ℓ}_{i}}{\partial {π}_{θ} ( {y}_{i} \vert x )} < 0 ,$$

so decreasing π_{θ}(yᵢ|x) reduces [symbol] ᵢ(θ).

Implication: These lemmas show that when optimizing each response independently, even low-quality responses receive upward pressure if their target weight

$${p}_{i}^{t a r g e t}$$

is nonzero. Moreover, multiple good responses compete with each other, causing contradictory optimization signals.

### Length as a Shortcut: Probability Inflation and Length-Induced Certainty

Without length normalization, the model can exploit shorter sequences to artificially inflate their probabilities. Even with length normalization, subtle effects arise from the interplay between sequence length and token-level uncertainty.

Lemma 3 (Length-Induced Probability Inflation). Shorter responses typically accumulate less negative log-probability because they have fewer tokens. Thus, holding per-token quality constant, shorter responses achieve higher overall probability, incentivizing the model to prefer brevity over meaningful improvement.

Proof Sketch: 1. Consider two responses y1, y2 with similar per-token likelihoods. 2. If |y₁|<|y₂|, then log π_{θ}(yᵢ|x)=−|y₁|c and log π_{θ}(y₂|x)=−|y₂|c for some average cost c>0. 3. Since |y₁|<|y₂|, e^{-|y}^{₁}^{|c}>e^{-|y}^{₂}^{|c}, so π_{θ}(y₁|x)>π_{θ}(y₂|x).

Observation 5.1 (Length-Induced Certainty). For certain sets of responses, increasing the length makes the sequence easier to predict token-by-token, lowering the average per-token negative log-probability. This suggests the model becomes more “certain” as sequences extend.

Reasoning Sketch: 1. Empirically observed and theoretically reasoned: once a semantic/syntactic structure is established, subsequent tokens are more predictable. 2. Thus, L̅(y), the average per-token negative log-probability, decreases as len(y) grows.

Lemma 4 (Length Reduction for Negative Responses). If the training objective penalizes high-probability negative responses, and longer sequences are more predictable (lower L̅(y)), then to increase L̅(y) for these negative responses, the model may shorten them. This can undermine efforts to produce richer responses.

Proof Sketch: 1. Suppose the system wants to reduce π_{θ}(y|x) for some negative response y. Equivalently, the system increases L̅(y). 2. Under the length-certainty assumption, longer responses have lower L̅(y). To raise L̅(y), the model can shorten y. 3. Thus, minimizing loss may encourage decreasing len(y), if that increases its per-token uncertainty, satisfying the requirement to reduce π_{θ}(y|x)

Implication: Even with length normalization, subtle incentives remain. If certain negative responses must be penalized, the model can exploit length manipulation to achieve the required uncertainty. This suggests that length normalization alone is insufficient for controlling response quality and justifies adding further constraints, such as EOS probability regularizers.

### Summary of Theoretical Insights

The above results and observations collectively show why simple reference-free InfoNCA-style objectives are not enough. Without careful design, these objectives: 1. Promote low-quality responses as long as they are not fully excluded. 2. Create competition among responses, delaying convergence to a collectively beneficial solution. 3. Incentivize trivial length-based shortcuts that do not yield genuinely higher-quality answers. 4. Under length normalization, subtle length-uncertainty dynamics still allow the model to shortcut improvements by manipulating response length.

These insights provide a theoretical foundation for integrating additional strategies-such as deviation based weighting, multi-preference sets, length normalization, and EOS-probability control-into the training objective. By doing so, models may be guided toward producing richer, more accurate, and user-aligned responses, overcoming the subtle incentive structures uncovered by these lemmas and the length-certainty observation.

The Reference Free Alignment (REFA) approach offers computational advantages compared to reference-based methods. By eliminating the need for a reference model, REFA reduces memory requirements during training, as the system no longer needs to store and process a separate reference model alongside the policy model being optimized. This removal of reference model dependency streamlines the computational pipeline, eliminating the complex ratio modeling that previous approaches required. The simplified optimization process directly operates on scalar rewards or scores without computing and tracking these ratios, resulting in more efficient training iterations and reduced computational overhead. Additionally, by sidestepping the reference model calculations for log-probability comparisons, REFA enables faster training convergence while maintaining or improving effectiveness compared to reference-based methods. This computational efficiency makes REFA particularly valuable for large-scale language model training scenarios where resource optimization is critical, allowing for more effective utilization of available computational resources while achieving good alignment results.

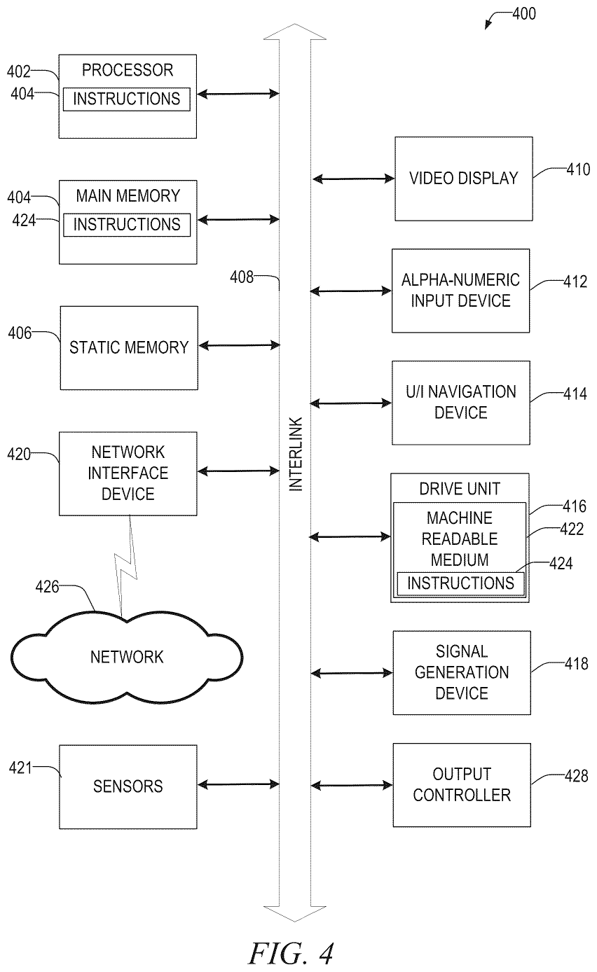

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 400 may be, be a portion of, or implement any of the devices of FIG. 1, perform the methods of FIG. 2, and/or be configured with one or more of the components of FIG. 3.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

### Other Notes and Examples

Example 1 is a computer-implemented method for training a language model without a reference model, the method comprising: identifying a dataset comprising queries and associated responses, each response having a reward value; for each query: computing a mean reward by averaging the reward values associated with each of the responses; partitioning the associated responses into a first set containing responses with associated rewards that are above the mean reward and a second set containing responses with associated rewards that are below the mean reward; computing quality scores for each response, the quality score representing an length normalized measure of a certainty of the language model in generating each token in the response; calculating deviation-based weights for each response based on a difference between the response's associated reward and the mean reward; computing a first partition function by applying the deviation-based weights to the quality score, and summing resulting weighted factors for responses in the first set; computing a second partition function by applying the deviation-based weights to the quality score, and summing resulting weighted factors for responses in the second set; computing a loss function based upon the first partition function and second partition function; and computing an overall dataset loss by averaging individual loss functions across the dataset; and updating model parameters using gradient descent based on the overall dataset loss.
In Example 2, the subject matter of Example 1 includes, calculating an end-of-sequence (EOS) regularizer by determining probabilities of generating an end token at positions corresponding to annotated response endings in the dataset, and applying a scaling factor to the determined probabilities of generating the end token; and wherein computing the loss function by combining the first partition function and the second partition function further includes computing the loss function using the EOS regularizer.
In Example 3, the subject matter of Example 2 includes, wherein calculating the EOS regularizer comprises penalizing early termination tokens to prevent the language model from artificially shortening responses.
In Example 4, the subject matter of Examples 1-3 includes, wherein computing the quality score comprises dividing a sum of token-level log probabilities by a total number of tokens in the response.
In Example 5, the subject matter of Examples 1-4 includes, wherein calculating the deviation-based weights comprises applying an exponential function to the difference between each response's reward and the mean reward.
In Example 6, the subject matter of Examples 1-5 includes, wherein computing the first partition function and second partition function further comprises applying an inverse temperature parameter to control distribution sharpness.
In Example 7, the subject matter of Examples 1-6 includes, wherein computing the second partition function further comprises applying a negative set weighting factor to control penalization of responses below the mean reward.
In Example 8, the subject matter of Examples 1-7 includes, wherein calculating deviation-based weights comprises raising the difference between the response's reward and mean reward to a power value.
Example 9 is a computing device for training a language model without a reference model, the computing device comprising: a hardware processor; a memory, the memory storing instructions, which when executed by the hardware processor cause the computing device to perform operations comprising: identifying a dataset comprising queries and associated responses, each response having a reward value; for each query: computing a mean reward by averaging the reward values associated with each of the responses; partitioning the associated responses into a first set containing responses with associated rewards that are above the mean reward and a second set containing responses with associated rewards that are below the mean reward; computing quality scores for each response, the quality score representing a length normalized measure of a certainty of the language model in generating each token in the response; calculating deviation-based weights for each response based on a difference between the response's associated reward and the mean reward; computing a first partition function by applying the deviation-based weights to the quality score, and summing resulting weighted factors for responses in the first set; computing a second partition function by applying the deviation-based weights to the quality score, and summing resulting weighted factors for responses in the second set; computing a loss function based upon the first partition function and second partition function; and computing an overall dataset loss by averaging individual loss functions across the dataset; and updating model parameters using gradient descent based on the overall dataset loss.
In Example 10, the subject matter of Example 9 includes, wherein the operations further comprise: calculating an end-of-sequence (EOS) regularizer by determining probabilities of generating an end token at positions corresponding to annotated response endings in the dataset, and applying a scaling factor to the determined probabilities of generating the end token; and wherein the operation of computing the loss function by combining the first partition function and the second partition function further includes computing the loss function using the EOS regularizer.
In Example 11, the subject matter of Example 10 includes, wherein the operation of calculating the EOS regularizer comprises penalizing early termination tokens to prevent the language model from artificially shortening responses.
In Example 12, the subject matter of Examples 9-11 includes, wherein the operation of computing the quality score comprises dividing a sum of token-level log probabilities by a total number of tokens in the response.
In Example 13, the subject matter of Examples 9-12 includes, wherein the operation of calculating the deviation-based weights comprises applying an exponential function to the difference between each response's reward and the mean reward.
In Example 14, the subject matter of Examples 9-13 includes, wherein the operation of computing the first partition function and second partition function further comprises applying an inverse temperature parameter to control distribution sharpness.
In Example 15, the subject matter of Examples 9-14 includes, wherein the operation of computing the second partition function further comprises applying a negative set weighting factor to control penalization of responses below the mean reward.
In Example 16, the subject matter of Examples 9-15 includes, wherein the operation of calculating deviation-based weights comprises raising the difference between the response's reward and mean reward to a power value.
Example 17 is a non-transitory machine-readable medium, storing instructions for training a language model without a reference model, the instructions, which when executed, cause the machine to perform operations comprising: identifying a dataset comprising queries and associated responses, each response having a reward value; for each query: computing a mean reward by averaging the reward values associated with each of the responses; partitioning the associated responses into a first set containing responses with associated rewards that are above the mean reward and a second set containing responses with associated rewards that are below the mean reward; computing quality scores for each response, the quality score representing a length normalized measure of a certainty of the language model in generating each token in the response; calculating deviation-based weights for each response based on a difference between the response's associated reward and the mean reward; computing a first partition function by applying the deviation-based weights to the quality score, and summing resulting weighted factors for responses in the first set; computing a second partition function by applying the deviation-based weights to the quality score, and summing resulting weighted factors for responses in the second set; computing a loss function based upon the first partition function and second partition function; and computing an overall dataset loss by averaging individual loss functions across the dataset; and updating model parameters using gradient descent based on the overall dataset loss.
In Example 18, the subject matter of Example 17 includes, wherein the operations further comprise: calculating an end-of-sequence (EOS) regularizer by determining probabilities of generating an end token at positions corresponding to annotated response endings in the dataset, and applying a scaling factor to the determined probabilities of generating the end token; and wherein the operation of computing the loss function by combining the first partition function and the second partition function further includes computing the loss function using the EOS regularizer.
In Example 19, the subject matter of Example 18 includes, wherein the operation of calculating the EOS regularizer comprises penalizing early termination tokens to prevent the language model from artificially shortening responses.
In Example 20, the subject matter of Examples 17-19 includes, wherein the operation of computing the quality score comprises dividing a sum of token-level log probabilities by a total number of tokens in the response.
In Example 21, the subject matter of Examples 17-20 includes, wherein the operation of calculating the deviation-based weights comprises applying an exponential function to the difference between each response's reward and the mean reward.
In Example 22, the subject matter of Examples 17-21 includes, wherein the operation of computing the first partition function and second partition function further comprises applying an inverse temperature parameter to control distribution sharpness.
In Example 23, the subject matter of Examples 17-22 includes, wherein the operation of computing the second partition function further comprises applying a negative set weighting factor to control penalization of responses below the mean reward.
In Example 24, the subject matter of Examples 17-23 includes, wherein the operation of calculating deviation-based weights comprises raising the difference between the response's reward and mean reward to a power value.
Example 25 is at least one machine-readable medium including instructions that, when executed by processing circuitry, cause the processing circuitry to perform operations to implement of any of Examples 1-24.
Example 26 is an apparatus comprising means to implement of any of Examples 1-24.
Example 27 is a system to implement of any of Examples 1-24.
Example 28 is a method to implement of any of Examples 1-24.

What is claimed is:

1. A computer-implemented method for training a language model without a reference model, the method comprising:
identifying a dataset comprising queries and associated responses, each response having a reward value;
for each query:
computing a mean reward by averaging the reward values associated with each of the responses;
partitioning the associated responses into a first set containing responses with associated rewards that are above the mean reward and a second set containing responses with associated rewards that are below the mean reward;
computing quality scores for each response, the quality score representing an length normalized measure of a certainty of the language model in generating each token in the response;
calculating deviation-based weights for each response based on a difference between the response's associated reward and the mean reward;
computing a first partition function by applying the deviation-based weights to the quality score, and summing resulting weighted factors for responses in the first set;
computing a second partition function by applying the deviation-based weights to the quality score, and summing resulting weighted factors for responses in the second set;
computing a loss function based upon the first partition function and second partition function; and
computing an overall dataset loss by averaging individual loss functions across the dataset; and
updating model parameters using gradient descent based on the overall dataset loss.

2. The method of claim 1, further comprising: calculating an end-of-sequence (EOS) regularizer by determining probabilities of generating an end token at positions corresponding to annotated response endings in the dataset, and applying a scaling factor to the determined probabilities of generating the end token; and wherein computing the loss function by combining the first partition function and the second partition function further includes computing the loss function using the EOS regularizer.

3. The method of claim 2, wherein calculating the EOS regularizer comprises penalizing early termination tokens to prevent the language model from artificially shortening responses.

4. The method of claim 1, wherein computing the quality score comprises dividing a sum of token-level log probabilities by a total number of tokens in the response.

5. The method of claim 1, wherein calculating the deviation-based weights comprises applying an exponential function to the difference between each response's reward and the mean reward.

6. The method of claim 1, wherein computing the first partition function and second partition function further comprises applying an inverse temperature parameter to control distribution sharpness.

7. The method of claim 1, wherein computing the second partition function further comprises applying a negative set weighting factor to control penalization of responses below the mean reward.

8. The method of claim 1, wherein calculating deviation-based weights comprises raising the difference between the response's reward and mean reward to a power value.

9. A computing device for training a language model without a reference model, the computing device comprising:
a hardware processor;
a memory, the memory storing instructions, which when executed by the hardware processor cause the computing device to perform operations comprising:
identifying a dataset comprising queries and associated responses, each response having a reward value;
for each query:
computing a mean reward by averaging the reward values associated with each of the responses;
partitioning the associated responses into a first set containing responses with associated rewards that are above the mean reward and a second set containing responses with associated rewards that are below the mean reward;
computing quality scores for each response, the quality score representing a length normalized measure of a certainty of the language model in generating each token in the response;
calculating deviation-based weights for each response based on a difference between the response's associated reward and the mean reward;
computing a first partition function by applying the deviation-based weights to the quality score, and summing resulting weighted factors for responses in the first set;
computing a second partition function by applying the deviation-based weights to the quality score, and summing resulting weighted factors for responses in the second set;
computing a loss function based upon the first partition function and second partition function; and
computing an overall dataset loss by averaging individual loss functions across the dataset; and
updating model parameters using gradient descent based on the overall dataset loss.

10. The computing device of claim 9, wherein the operations further comprise:
calculating an end-of-sequence (EOS) regularizer by determining probabilities of generating an end token at positions corresponding to annotated response endings in the dataset, and applying a scaling factor to the determined probabilities of generating the end token; and
wherein the operation of computing the loss function by combining the first partition function and the second partition function further includes computing the loss function using the EOS regularizer.

11. The computing device of claim 10, wherein the operation of calculating the EOS regularizer comprises penalizing early termination tokens to prevent the language model from artificially shortening responses.

12. The computing device of claim 9, wherein the operation of computing the quality score comprises dividing a sum of token-level log probabilities by a total number of tokens in the response.

13. The computing device of claim 9, wherein the operation of calculating the deviation-based weights comprises applying an exponential function to the difference between each response's reward and the mean reward.

14. The computing device of claim 9, wherein the operation of computing the first partition function and second partition function further comprises applying an inverse temperature parameter to control distribution sharpness.

15. The computing device of claim 9, wherein the operation of computing the second partition function further comprises applying a negative set weighting factor to control penalization of responses below the mean reward.

16. The computing device of claim 9, wherein the operation of calculating deviation-based weights comprises raising the difference between the response's reward and mean reward to a power value.

17. A non-transitory machine-readable medium, storing instructions for training a language model without a reference model, the instructions, which when executed, cause a machine to perform operations comprising:
identifying a dataset comprising queries and associated responses, each response having a reward value;
for each query:
computing a mean reward by averaging the reward values associated with each of the responses;
partitioning the associated responses into a first set containing responses with associated rewards that are above the mean reward and a second set containing responses with associated rewards that are below the mean reward;
computing quality scores for each response, the quality score representing a length normalized measure of a certainty of the language model in generating each token in the response;
calculating deviation-based weights for each response based on a difference between the response's associated reward and the mean reward;
computing a first partition function by applying the deviation-based weights to the quality score, and summing resulting weighted factors for responses in the first set;
computing a second partition function by applying the deviation-based weights to the quality score, and summing resulting weighted factors for responses in the second set;
computing a loss function based upon the first partition function and second partition function; and
computing an overall dataset loss by averaging individual loss functions across the dataset; and
updating model parameters using gradient descent based on the overall dataset loss.

18. The non-transitory machine-readable medium of claim 17, wherein the operations further comprise:
calculating an end-of-sequence (EOS) regularizer by determining probabilities of generating an end token at positions corresponding to annotated response endings in the dataset, and applying a scaling factor to the determined probabilities of generating the end token; and
wherein the operation of computing the loss function by combining the first partition function and the second partition function further includes computing the loss function using the EOS regularizer.

19. The non-transitory machine-readable medium of claim 18, wherein the operation of calculating the EOS regularizer comprises penalizing early termination tokens to prevent the language model from artificially shortening responses.

20. The non-transitory machine-readable medium of claim 17, wherein the operation of computing the quality score comprises dividing a sum of token-level log probabilities by a total number of tokens in the response.
